(19) United States
(12) Patent Application Publication
(10) Pub. No.: US 2006/0285225 A1
(43) Pub. Date: Dec. 21, 2006

(54) Zoom lens for DLP projector

(75) Inventors: Yi-Chin Fang, Rende Shiang (TW); Yao-Chien Cheng, Rende Shiang (TW)

Correspondence Address: LADAS & PARRY, 26 WEST 61ST STREET, NEW YORK, NY, 10023, US

(73) Assignee: CHILIN OPTRONICS CORP.

(21) Appl. No.: 11/333,058

(22) Filed: Jan. 17, 2006

(30) Foreign Application Priority Data
Jun. 16, 2005 (TW) 094119927

(51) Int. Cl. G02B 15/14

(52) U.S. Cl. 359/690

(57) ABSTRACT

The invention relates to a zoom lens for DLP projector. The zoom lens of the invention comprises a focus group, a zoom group and a compensation group. The zoom group comprises three zoom units with positive, negative, positive optical power respectively. The compensation group comprises a first compensation unit, a second compensation unit, an aperture stop and a third compensation unit. Corresponding to the aperture stop, the compensation lens of the compensation units have positive radius, positive radius, positive radius and negative radius respectively. The zoom lens of the invention utilizes the zoom group and the compensation group so that firstly, the F-number of the zoom lens of the invention can be fixed at 2.2; secondly, the relative luminance of the zoom lens of the invention can be up to 60% even at extreme corner; thirdly, the tolerance of the zoom lens of the invention is comparatively excellent.

### BACKGROUND OF THE INVENTION

1. Field of the Invention

The invention relates to a zoom lens, particularly to a zoom lens for Non-Telecentric DLP projector.

2. Description of the Related Art

The conventional Digital Light Processing (DLP) projector with non-telecentric optical lens take advantages of sufficient illuminance on the projected image; however, its optical design is comparatively difficult due to nearly fixed exit pupil position. Little tolerance is allowed between the pupil of projection lens and optical engine. Additionally, the requirement of 1.33 times zoom design complicates this specific lens design.

Consequently, there is an existing need for a zoom lens to solve the above-mentioned problems.

### SUMMARY OF THE INVENTION

The invention presents a zoom lens for DLP projector. The zoom lens comprises a focus group, a zoom group, and a compensation group. The zoom group comprises a first zoom unit, a second zoom unit and a third zoom unit. The first zoom unit has positive optical power, the second zoom unit has negative optical power and the third zoom unit has positive optical power. The compensation group comprises a first compensation unit, a second compensation unit, an aperture stop and a third compensation unit. Corresponding to the aperture stop, the first compensation unit has a first compensation surface with positive radius; the second compensation unit has a second compensation surface with positive radius and a third compensation surface with positive radius, and the third compensation unit has a fourth compensation surface with positive radius.

The zoom lens of the invention controls the three zoom units of the zoom group with positive, negative and positive optical power respectively and the radius of the compensation surface of the compensation units the compensation group. Therefore firstly, the F-number of the zoom lens of the invention can be fixed at 2.2; secondly, the zoom lens of the invention can obtain better and stable luminance, the luminance can be up to 60% even at extreme corner; thirdly, the tolerance of the zoom lens of the invention is comparatively excellent.

### BRIEF DESCRIPTION OF THE DRAWINGS

FIG. 1 shows a zoom lens for DLP projector of the present invention.

### DETAILED DESCRIPTION OF THE INVENTION

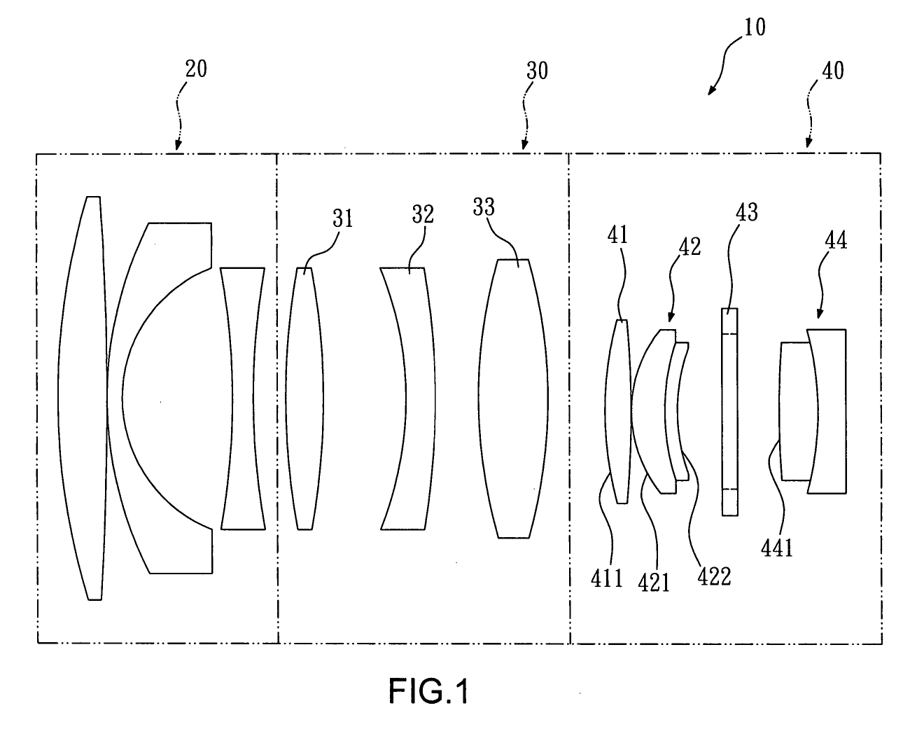

FIG. 1 shows the structure of a zoom lens 10 for DLP projector according to the present invention. The zoom lens of the present invention comprises a focus group 20, a zoom group 30 and a compensation group 40. The focus group 20 may be the same as the conventional focus group, thus it is not described in detail here.

The zoom group 30 comprises a first zoom unit 31, a second zoom unit 32 and a third zoom unit 33. The first zoom unit 31 is a convex lens with positive optical power. The second zoom unit 32 is a concave lens with negative optical power. The third zoom unit 33 is a convex lens with positive optical power. Thus, the three zoom units 31, 32, 33 are with positive optical power, negative optical power and positive optical power respectively so that the zoom lens 10 can zoom by 1.33 times.

The compensation group 40 comprises a first compensation unit 41, a second compensation unit 42, an aperture stop 43 and a third compensation unit 44. The first compensation unit 41 comprises a lens having a first compensation surface 411. Corresponding to the aperture stop 43, the first compensation unit 41 is disposed on the incident side of light; therefore, the first compensation surface 411 is defined with a positive radius.

The second compensation unit 42 comprises two lenses having a second compensation surface 421 and a third compensation surface 422. Corresponding to the aperture stop 43, the second compensation surface 421 is with positive radius and the third compensation surface 422 is with positive radius.

The third compensation unit 44 comprises a lens having a fourth compensation surface 441. Corresponding to the aperture stop 43, the fourth compensation surface 441 is disposed on the exiting side of light; therefore, the fourth compensation surface 441 is defined with a negative radius.

Preferably, the refraction ratio of all lenses of the zoom group 30 and the compensation group 40 are 1.6 to 1.9. In addition, the distance from the third compensation surface 422 to the center of the aperture stop 43 is larger than 3.5 millimeters, and the distance from the fourth compensation surface 441 to the center of the aperture stop 43 is larger than 2 millimeters.

Because the compensation surfaces 411, 421, 422, 441 of the compensation lenses 41, 42, 44 of the compensation unit 40 are set with various positive radius and negative radius respectively (the first compensation surfaces 411 with positive radius, the second compensation surfaces 421 with positive radius, the third compensation surfaces 422 with positive radius and the fourth compensation surfaces 441 with negative radius) and the refraction ratio is limited, the F-number of the zoom lens 10 of the invention can be fixed at 2.2 and the zoom lens of the invention can increase the luminance and the luminance can be up to 60% even at extreme corner. If the first compensation surfaces 411, the second compensation surfaces 421 and the third compensation surfaces 422 are not with positive radius, it is not easy to input the light and the luminance of the zoom lens cannot be increased.

The zoom lens of the invention controls the zoom units 31, 32, 33 of the zoom group 10 with positive, negative, positive optical power respectively, and control the compensation lenses 41, 42, 44 of the compensation unit 40 with positive radius, positive radius, positive radius and negative radius respectively corresponding to the aperture stop.

Therefore, utilizing the arrangement of the optical power of the zoom group and the radius of the compensation group, firstly, the F-number of the zoom lens 10 of the invention can be fixed at 2.2. Secondly, the zoom lens 10 of the invention can obtain better and staple luminance, the luminance can be up to 60% even at extreme corner. The zoom lens 10 utilizes only the zoom group 30 to zoom by 1.33 times; however, the conventional zoom lens must utilize five groups of zoom units to zoom by 1.33 times. Thirdly, the zoom lens of the invention can utilize less zoom unit to obtain the better tolerance.

While the embodiment of the present invention has been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. A zoom lens for DLP projector comprising:
a focus group;
a zoom group, having a first zoom unit, a second zoom unit and a third zoom unit, the first zoom unit with positive power, the second zoom unit with negative power and the third zoom unit with positive optical power; and
a compensation group, having a first compensation unit, a second compensation unit, an aperture stop and a third compensation unit, corresponding to the aperture stop, the first compensation unit having a first compensation surface with positive radius, the second compensation unit having a second compensation surface with positive radius and a third compensation surface with positive radius, and the third compensation unit having a fourth compensation surface with negative radius.

2. The zoom lens according to claim 1, wherein the refraction ratio of lenses of the focus group, the zoom group and the compensation group are 1.6 to 1.9.

3. The zoom lens according to claim 1, wherein the distance from the third compensation surface to the center of the aperture stop is larger than 3.5 millimeters.

4. The zoom lens according to claim 1, wherein the distance from the fourth compensation surface to the center of the aperture stop is larger than 2 millimeters.
